(19) United States
(12) Patent Application Publication
(10) Pub. No.: US 2026/0356215 A1
(43) Pub. Date: Nov. 12, 2026

(54) A FRAME FOR THE PROTECTION OF A BATTERY BOX OF A VEHICLE

(71) Applicant: AUTOTECH ENGINEERING S.L., Amorebieta-Etxano (ES)

(72) Inventors: Vanessa LOPERA CANO, Vanves (FR); Quentin GIRAUD DU POYET, Argenteuil (FR); David FORTAS, Rueil Malmaison (FR)

(21) Appl. No.: 19/132,991

(22) PCT Filed: Nov. 29, 2023
(86) PCT No.: PCT/EP2023/083482

§ 371 Date: May 27, 2025

(30) Foreign Application Priority Data
Nov. 30, 2022 (EP) 22383156.1

(51) Int. Cl. B60L 50/64; B60K 1/04; B60L 50/60

(52) U.S. Cl. CPC B60L 50/64; B60K 1/04; B60L 50/66; B60K 2001/0438

(57) ABSTRACT

The present disclosure relates to frames (10) for the protection of a battery box (20) of a vehicle, wherein the frame (10) is fixed to the battery box (20). The frame (10) comprises a first longitudinal outer member (11) directly attached to an underside of a first rocker (31) of the vehicle and a second longitudinal outer member (14) directly attached to an underside of a second rocker (32) of the vehicle. The frame (10) further comprises a plurality of cross-members (12, 16) underneath the battery box (20) connecting the first longitudinal outer member (11) to the second longitudinal outer member (14). The present disclosure further relates to a vehicle comprising such a frame.

The present application claims the benefit of EP22383156.1 filed on Nov. 30, 2022.

The present disclosure relates to frames for the protection of battery boxes of vehicles and to vehicles comprising such frames.

### BACKGROUND

Traction batteries are an essential part of electric and hybrid vehicles which provide power to an electric motor of the vehicle. The electronic and chemical nature of these batteries makes them particularly sensitive to high mechanical loads, e.g. crash impacts.

In order to ensure safety of passengers, and avoid malfunction, one of the challenges of the automotive industry is the protection of traction batteries in case of a collision.

Vehicles such as cars incorporate a structural skeleton designed to withstand and absorb impacts in case of e.g. collisions with other cars, obstacles or pedestrians. The structural skeleton of a car in this sense may include e.g. bumpers, pillars (A-pillar, B-pillar, C-pillar, D-pillar), side impact beams, rockers or sills, hinge pillars and shock absorbers.

In vehicles, traction batteries are generally placed inside a battery box, which is generally mounted in the lower area of the vehicle under a passenger cabin. In a crash event, the structural skeleton of the vehicle absorbs most of the impact energy but part of that energy may still be transmitted to the battery box.

To extend battery lifespan and protect them against external collisions, the automotive industry has put considerable effort into providing battery enclosures and load bearing structures suitable for electrically powered vehicles. Thus, a wide range of protection elements has been designed and engineered during the last years to accommodate and protect traction batteries.

The battery box may be made of materials which have high stiffness and strength and low weight. Steel battery boxes or battery trays as well as battery boxes made of polymeric (plastic) or composite components have been designed in order to improve battery protection in case of collisions. However, the battery box of an electrically powered vehicle may not always be configured to cope with the energy involved in a car crash. Problems of inwards intrusion in case of side impacts have been found.

One way of protecting the batteries in collisions may be to modify the structural characteristics of the body in white of the vehicle so that more energy can be absorbed and less impact energy reaches the battery box. E.g. rockers may be reinforced. However, modifying the body in white (BIW) of the vehicle may not always be a possibility due to space constraints, and it may affect the overall design of the vehicle undesirably.

Document US 2022/0134857 A1 discloses a frame-mounted battery enclosure. This document discloses a vehicle which comprises a vehicle frame with a first frame rail and a second frame rail. The battery enclosure disclosed includes a first side member and a second side member which are connected and deformable relative to the first and second frame rails of the vehicle. The frame rails are attached to the inside of the rockers.

It is a challenge to protect the integrity of battery boxes without significantly increasing the total weight of the vehicle or changing its design. There is a further challenge to safeguard the integrity of the battery box within given space constraints.

### SUMMARY

In a first aspect, a frame for the protection of a battery box of a vehicle is provided. The frame may be fixed to the battery box. The frame comprises a first longitudinal outer member directly attached to an underside of a first rocker of the vehicle and a second longitudinal outer member directly attached to an underside of a second rocker of the vehicle. The frame comprises a plurality of cross-members underneath the battery box for connecting the first longitudinal outer member to the second longitudinal outer member.

The load received by the battery box may be significantly decreased because the rocker may primarily transmit energy to the frame directly attached to it. The frame may absorb and transmit energy produced in an impact and may therefore protect the integrity of the battery box. The protection of the battery box may be achieved in a simple and efficient manner without the need of additional elements.

Additionally, the plurality of cross-members may transfer energy during a vehicle impact to the other side of the vehicle, distributing the energy and reducing a damage caused to the battery box. By attaching the outer members directly to an underside of the rockers, no space between the rockers is occupied. The space between the rockers may thus be occupied by the battery box. The size of the battery box may be increased, which allows for battery cells of increased dimensions, or the arrangement of systems or reinforcements in the battery box.

Throughout the present disclosure, a battery box may herein be regarded as an enclosure of a battery, wherein the battery may be made up of a plurality of battery cells. A battery box may include a battery tray made of e.g. steel or polymer reinforced composite and a cover.

An underside of the rocker may be regarded as the bottom or lower side or surface of the rocker.

In some examples, the plurality of cross-members connecting the first longitudinal outer member to the second longitudinal outer member may be tubes or may be at least partially tubular. In some examples the tubes may be made of steel. Steel tubes may provide cross-members with resistance to high loads and which are efficient in distributing energy.

In other examples, the plurality of cross-members connecting the first longitudinal outer member to the second longitudinal outer member may be stamped beams. Stamping, and particularly hot stamping, is a well-known technology for providing components with high strength and a suitable shape.

In some examples, the plurality of cross-members may comprise at least one cross-member that is curved along a transverse direction. On the one hand, a curvature may predefine kinematics of deformation in case of impact, on the other hand, it can help to transform a lateral impact with lateral deformation into a deformation extending along a longitudinal direction, thus reducing the energy and impact that needs to be absorbed in the lateral direction.

In some examples, two or more of the cross-members may have the same size and shape. In some examples, all the cross-members may have the same size and shape. This can facilitate manufacture and assembly of the battery protection frame.

In some examples, one or more of the cross-members comprise a first end portion for connecting to the first longitudinal outer member, a second end portion for connecting to the second longitudinal outer member, and a curved middle portion. Curved cross-members may have an increased buckling strength compared to straight cross-members. A lateral impact may thus be absorbed better or the deformation in case of an impact may be controlled better.

In some examples, the first and second end portions are positioned in substantially a same longitudinal position, wherein the curved middle portion is positioned more rearwardly or forwardly than the first and second end portions. In case of a side impact, a lateral deformation of the outer members and cross-members may at least be partly converted in a longitudinal deformation.

In some examples, two adjacent cross-members of the plurality of cross-members are joined to each other at their curved middle portions. Curved cross-members may enable energy transfer from one end portion to the other end portion. In addition, energy that is to be absorbed in a collision may also be transferred in a longitudinal direction of the vehicle between adjacent curved cross-members. The loads of a lateral impact may be transmitted along the length of the vehicle.

In some examples, the plurality of cross-members may be joined to the first and second longitudinal outer members by brackets. Brackets may be regarded as structural elements. They may be configured to receive the cross-members at an inside of the bracket. One or more of the brackets may be configured to receive more than one cross-member.

In some examples, the first and second longitudinal outer members and the cross-members are joined to the brackets by welding.

Throughout the present disclosure, a longitudinal direction, a vertical direction and a lateral direction are defined for providing spatial orientation components of a (structural skeleton of a) vehicle. These directions are substantially perpendicular to each other. Thus, the longitudinal outer members have a length along the longitudinal direction (the longitudinal direction would be generally parallel to a driving direction of the vehicle in which the component is mounted), a height along the vertical direction and a width along the lateral direction. E.g. rockers may generally extend along a longitudinal direction and the cross-members generally extend in the lateral direction between the outer longitudinal members.

### BRIEF DESCRIPTION OF THE DRAWINGS

Non-limiting examples of the present disclosure will be described in the following, with reference to the appended figures, in which:

FIG. 1A shows an example of a top view of a frame for the protection of a battery box of a vehicle;

FIG. 1B shows a bottom view of a vehicle comprising the frame for the protection of a battery box in FIG. 1A;

FIG. 1C shows a front view of another example of a portion of a frame for the protection of a battery box of a vehicle;

FIG. 1D shows a top view of a lateral end portion of the frame in FIG. 1A;

FIG. 2 shows a top perspective view of a further example of a frame for the protection of a battery box of a vehicle;

FIG. 3 shows a top perspective view of yet a further example of a frame for the protection of a battery box of a vehicle;

FIG. 4 shows a bottom view of another example of a frame for the protection of a battery box of a vehicle;

FIG. 5A shows a top perspective view of a further example of a frame for the protection of a battery box of a vehicle;

FIG. 5B shows a top view of a lateral end portion of the frame in FIG. 5A;

FIG. 6 shows an example of a front view of a portion of a frame for the protection of a battery box of a vehicle fixed to a battery box and directly attached to a rocker of the vehicle;

FIG. 7 shows an example of a top perspective view of a frame for the protection of a battery box of a vehicle fixed to a battery box and directly attached to the rockers of the vehicle.

The figures refer to example implementations and may only be used as an aid for understanding the claimed subject matter, not for limiting it in any sense.

### DETAILED DESCRIPTION OF EXAMPLES

In these figures, the same reference signs have been used in different figures to designate matching elements.

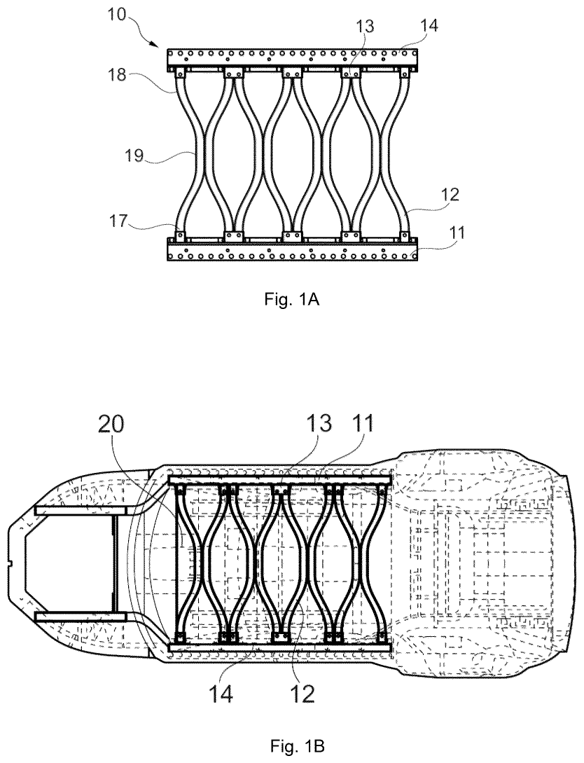

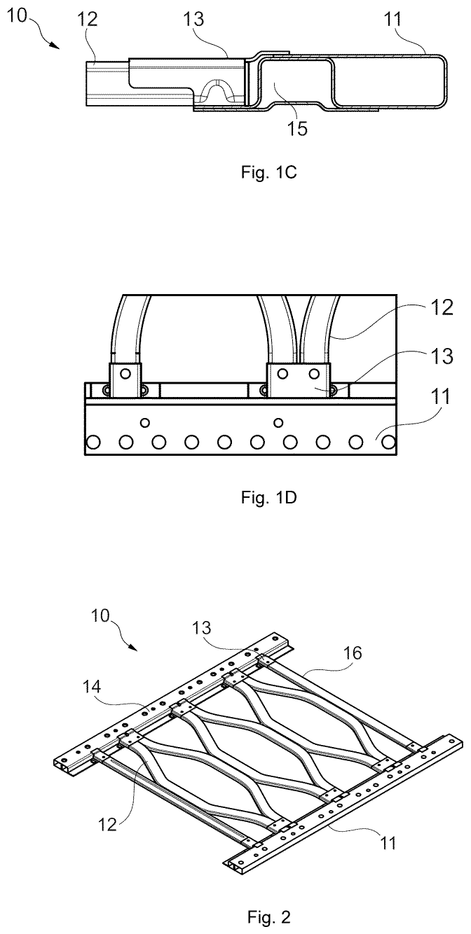

FIGS. 1A-1D schematically illustrates a frame 10 for the protection of a battery box 20 of a vehicle according to an example of the present disclosure. In the example of FIGS. 1A-1D , the vehicle may be an electric van.

The frame is fixed to the battery box 20 (not shown in this figure). The frame 10 comprises a first longitudinal outer member 11, a second longitudinal outer member 14 and a plurality of cross-members 12 underneath the battery box 20 connecting the first longitudinal outer member 11 to the second longitudinal outer member 14. The first longitudinal outer member 11 and the second longitudinal outer member 14 of the frame 10 are directly attached to an underside of a first and second rocker 31, 32 of the vehicle respectively (not shown).

In case of a lateral impact, one of the first and second longitudinal outer members 11, 14 may absorb energy and transfer it to the other longitudinal outer member of the frame, thereby reducing the amount of impact energy received by the battery box 20.

As schematically illustrated in FIG. 1A, the plurality of cross-members may comprise at least a curved cross-member, i.e., the cross-member may be curved in the lateral direction. One or more of the cross-members may comprise a first end portion 17 for connecting to the first longitudinal outer member 11, a second end portion 18 for connecting to the second longitudinal outer member 14, and a curved middle portion 19, wherein the first and second end portions 17, 18 may be positioned in substantially a same longitudinal position, and wherein the curved middle portion 19 may be positioned more rearwardly or forwardly of the first and second end portions 17, 18.

Connecting the longitudinal outer members 11, 14 with curved cross-members 12 may lead to a higher energy transfer between one longitudinal outer member and the other, leading to enhanced distribution of forces and to a reduction of the energy received by the battery box 20. Curved cross-members may have an increased buckling strength compared to straight cross-members. Structural integrity of the battery box 20 after a crash event may be maintained.

As shown in FIG. 1A, two adjacent cross-members of the plurality of cross-members may be joined to each other at their curved middle portions 19, e. g., by welding. In some examples, a cross-member may only be joined to a single other adjacent cross-member. An inner space between adjacent curved cross-members which are not joined to each other may be defined. In some examples, the inner space may define a substantially rhombus space.

In case cross-members are joined to each other, energy and loads generated during a collision may not only be distributed from a cross-member 12 to a longitudinal outer member 11, 14 but also between adjacent curved cross-members 12, in a longitudinal direction of the vehicle. The connection between adjacent curved cross-members 12 may enhance transmission of loads and may further reduce the negative effect that collisions may inflict on the battery box 20. In particular, the intrusion of a rocker and/or a battery box inwardly may be reduced or avoided, because the loads are transmitted and diverted elsewhere to a larger extent.

In some examples, two or more of the cross-members 12 connecting the first longitudinal outer member 11 of the frame 10 to the second longitudinal outer member 14 may have the same size and shape. Identical cross-members 12 may simplify the structure of the frame and therefore, simplify the manufacturing process and the assembly of the battery protection frame. In some examples, like in FIG. 1A, all cross-members are identical in shape.

In the example of FIG. 1A, eight cross-members may be used. The number of cross-members may be varied in other examples depending e.g. on the length of the rockers of a vehicle or the length of the battery box of a vehicle.

In some examples, the first and second longitudinal outer members 11, 14 may be roll formed. In other examples, hot or cold stamping may be used to form the longitudinal outer members. In some examples, two parts may be formed, e.g. by hot or cold stamping and these subsequently attached to each other to form a closed cross-section.

In some examples, the longitudinal outer members 11, 14 may be made of steel. In some examples, martensitic steels may be used. In some examples, the longitudinal outer members 11, 14 may be made of ultra high strength steel. The use of ultra high strength steel may provide light longitudinal outer members 11, 14 which are also strong and resistant. Battery box 20 protection without a significant increase in weight of the vehicle may be achieved.

An ultra high strength steel may herein be regarded as a steel having an ultimate tensile strength of at least 1.000 MPa, and optionally at least 1.500 MPa. An ultra high strength may obtain such ultimate tensile strength after a suitable heat treatment. In particular, an ultimate tensile strength may obtain a martensitic microstructure after a suitable heat treatment. Boron steels like 22 MnB5 or 37 MnB5 are two examples of suitable steels. In other examples, a martensitic cold forming steel might be used, e.g. MS 1200.

In some examples, the plurality of cross-members 12 may be hydroformed. In some examples, the plurality of cross-members 12 may be tubes. The tubes may be made of steel. In further examples, the plurality of cross-members 12 may be made of an ultra high strength steel.

As shown in FIG. 1A, the plurality of cross-members 12 may be joined to the first and second longitudinal outer members 11, 14, particularly, the cross-members 12 may be joined at corresponding flanges of the longitudinal outer members. In some examples, like in FIG. 1A, the cross-members may be attached to the longitudinal outer members with brackets 13.

The brackets may be configured to receive the cross-members at an inside of the bracket. In some examples, the brackets 13 may join the end portions 17, 18 of the cross-members 12 to the longitudinal outer members 11, 14. This may also be seen in FIG. 1D, which shows a lateral end portion of the frame in FIG. 1A.

At a front end and at the rear end of the frame 10 a single cross-member is connected to the outer longitudinal members. In examples, a single bracket 13 may join end portions of two adjacent cross-members 12 to a longitudinal outer member 11, 14. Brackets 13 may receive end portions of adjacent cross-members 12. The end portions of adjacent cross-members may be welded to each other and to the bracket 13. A lateral impact which affects a bracket will thus affect multiple cross-members.

One cross-member (e.g. a curved tube) may be attached to an adjacent cross-member at the outer longitudinal members, and the same cross-member may be attached to another adjacent cross-member in a central area underneath the battery box. So a cross-member is connected to adjacent cross-members on either side.

In some examples a bracket 13 may be a structural element made of steel. The brackets 13 may have any suitable shape for joining the longitudinal outer members 11, 14 to the cross-members 12. In some examples, the brackets 13 may be substantially rectangular. The brackets 13 may be wide enough for ensuring a safe joint of the cross-members 12 to the longitudinal outer members 11, 14.

In some examples, the first and second longitudinal outer members 11, 14 and the cross-members 12 may be joined to the brackets 13 by welding.

FIG. 1B schematically represents a vehicle comprising the frame 10 of FIG. 1A. The frame 10 is fixed to a battery box 20. The frame 10 comprises a plurality of cross-members 12 underneath the battery box 20 joining the first longitudinal outer member 11 to the second longitudinal outer member 14. The first longitudinal outer member 11 of the frame 10 is directly attached to an underside of a first rocker of the vehicle and the second longitudinal outer member 14 of the frame 10 is directly attached to an underside of a second rocker of the vehicle.

As may be seen in FIG. 1B, the longitudinal outer members 11, 14 of the frame 10 may extend between the front and rear wheels of the vehicle. In some examples, the length of the longitudinal outer members 11, 14 may correspond to at least the length of the battery box 20. In some examples, the length and width of the longitudinal outer members 11, 14 may be similar to the length and width of the rockers 31, 32 of the vehicle. In some examples the length of the longitudinal outer members 11, 14 may extend over the entire length of the battery box, or at least 70% of the length of the battery box. In examples, the length of the longitudinal outer members 11, 14 may be between 70 and 90% of a length of the rocker. In some examples, the longitudinal outer members 11, 14 may have width of e.g. 80.mm. The width of the longitudinal outer members may be e.g. 50-100% of a width of the rockers they are attached to.

FIG. 1C illustrates a section of another example of a frame 10 for the protection of a battery box 20 of a vehicle. In this example, the first and second longitudinal outer members 11, 14 of the frame 10 may have a substantially eight-shaped cross-section, i.e. two cavities or hollow cells separated by a middle wall. Longitudinal outer members with such an eight-shaped cross-section may enhance absorption of energy at the beginning of the crash event while also reducing the weight of the frame 10. An eight-shaped cross-section may be formed e.g., with roll-forming. Eight-shaped cross-sections may also be formed by joining two hot and/or cold stamped components to each other.

In other examples, the first and second longitudinal outer members 11, 14 may be completely hollow. Although not shown in FIG. 1C, the frame is fixed to the battery box and the first and second longitudinal outer members 11, 14 are directly attached to an underside of the rockers of the vehicle.

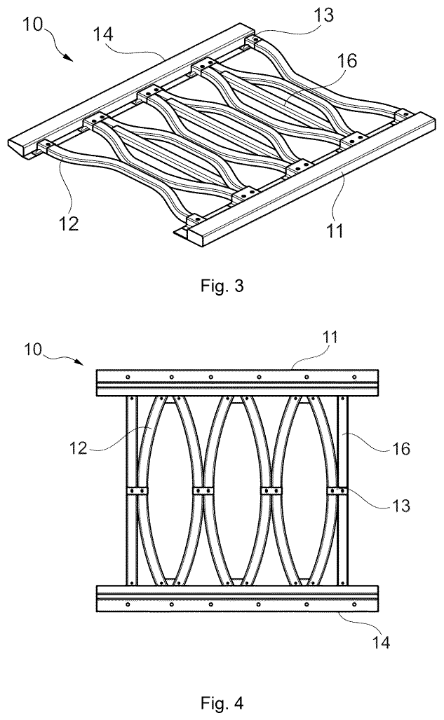

In further examples, as illustrated e.g., in FIGS. 2 and 3, the frame 10 may comprise one or more straight cross-members 16 connecting the first longitudinal outer member 11 to the second longitudinal outer member 14.

FIG. 2 shows an example of a frame 10 comprising a straight cross-member 16 at the front end of the frame and a straight cross-member at the rear end of the frame. The other cross-members are curved in a similar manner as shown in the example of FIGS. 1A, 1B and 1D. The curved cross-members may be attached to adjacent curved cross-members in a manner similar to what was described with reference to FIG. 1A.

The straight cross-members at the front end and/or the straight cross-member at the rear end may be joined to the corresponding adjacent curved cross-members by e.g. welding. A first and second end of the straight cross-members 16 may be joined to the first and second longitudinal outer members with brackets 13. The cross-members 12 in this example may be tubular cross-members as illustrated with reference to FIG. 1A.

In some other examples, as illustrated in FIG. 3, the straight cross-members 16 may be located between adjacent curved cross-members 12. In some examples, a straight cross-member 16 may be located between curved cross-members which are not joined to each other.

In the illustrated example in FIG. 3, a single bracket 13 may join three cross-members 12 to an outer longitudinal member. More particularly, in this example, one straight cross-member and two curved cross-members are joined to a longitudinal outer member 11, 14 using a single bracket. At the opposite end, a similar arrangement of brackets receiving multiple cross-members may be found.

The multiple cross-members may be welded to each other and to the brackets. A wider area underneath the battery box and between the longitudinal outer members 11, 14 may be covered by the cross-members 12, enabling better distribution of energy and potential reduction of battery damage.

In some examples, like the examples of FIGS. 1A, 1B and 3, the frame 10 may comprise at least eight curved cross-members 12. In other examples, the frame 10 may comprise at least eight curved cross-members 12 and at least three straight cross members 16.

In a further example, as illustrated in FIG. 4, the plurality of cross-members 12 of the frame 10 may be roll-formed tubes. The roll-formed tubes may be joined to the first and second longitudinal outer members 11, 14 with brackets.

In this example, as may be seen in FIG. 4, two adjacent curved cross-members 12 of the plurality of curved cross-members of the frame 10 may be joined to each other along their curved middle portions 19 by a bracket 13 rather than by welding cross-members to each other which was illustrated in the examples of FIGS. 1A-3 .

Further, the frame 10 may comprise two straight roll-formed tubes at the front end and rear end of the frame. As shown in FIG. 4, each of the straight roll-formed tubes may be joined to the middle portion of an adjacent curved roll-formed tube by a bracket.

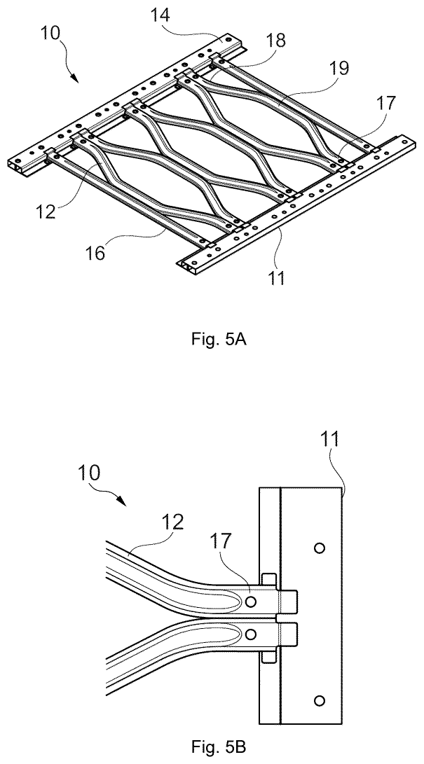

FIGS. 5A and 5B illustrate another example of a frame 10 for the protection of a battery box 20 of a vehicle. In this example, the plurality of cross-members 12 connecting the first longitudinal outer member 11 to the second longitudinal outer member 14 may be beams. The beams may be made of steel e.g. ultra high strength steel.

The cross-members in the example of FIG. 5 may be formed by stamping. The cross-section of stamped cross-members may be substantially hat-shaped. The cross-section may comprise a bottom wall and a first and second sidewall. The cross-section may further comprise flanges extending outwardly from the first and second sidewalls.

The cross-members in this example may have an open cross-section. In some examples, cover plates may be provided to provide a cross-member with a closed cross-section and a corresponding increase in torsional strength and stiffness.

Stamped cross-members may be joined to the outer longitudinal members using brackets in a manner similar to what was illustrated before. However, stamped cross-members may also be formed in such a manner that they include one or more flange(s) for attachment to the longitudinal outer members.

In some examples, the beams may be hot stamped beams. In other examples, the beams may be cold stamped beams. Hot stamping may involve heating a blank to a suitable temperature, particularly to above an austenization temperature, and more particularly to above an Ac3 temperature. After suitable austenization, the blanks may be positioned in a press in which the blanks are deformed to given them their final shape, and in which they are rapidly cooled (quenched, particularly at a rate that is higher than the critical cooling rate for the steel used) to obtain a martensitic microstructure.

Ultra high strengh steel (UHSS) like e.g. boron steel may be used to obtain ultimate tensile strenght of 1.000 MPa or more, particularly 1.500 MPa or more. Using ultra high strength steel may provide light weight cross-members which at the same time are stiff and strong.

In the example of 5A, the cross-members comprise six curved stamped beams comprising a first end portion connecting to the first longitudinal outer member, a second end portion connecting to the second longitudinal outer member and a curved middle portion. Adjacent cross-members may be joined to each other at their curved middle portions by e.g. welding. The frame 10 of FIG. 5a further comprises two straight stamped beams at or near the front end and the rear end of the frame which may be joined to the middle portion of an adjacent curved stamped beam by e.g. welding.

Further, the stamped beams may comprise a hat-shaped cross-section. As illustrated in FIG. 5B, the end portions 17, 18 of the stamped beams may be shaped such that the cross-members may be directly joined to the longitudinal outer members without any other extra element (e.g. without a bracket). The end portions 17, 18 of the stamped beams may be directly joined to the longitudinal outer members by welding e.g. spot welding. A simpler frame with less components and faster assembly may be provided.

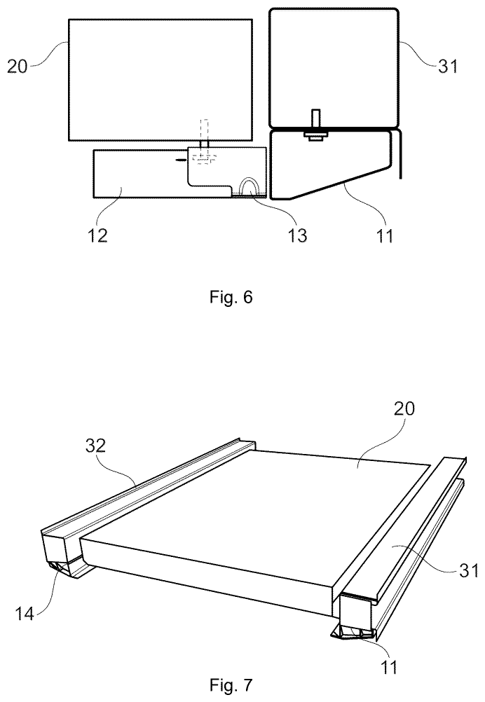

FIG. 6 schematically illustrates a further example of a frame 10 for the protection of a battery box 20 of a vehicle. The frame 10 is fixed to a battery box 20 and a first longitudinal member of the frame is directly attached to an underside of a first rocker 31. A second longitudinal outer member 14 of the frame 10 is directly attached to an underside of a second rocker 32 of the vehicle (not shown). FIG. 6 shows a first longitudinal outer member 11 directly attached to an underside of a first rocker 31 with screws. In some examples, the first and second longitudinal outer members may be directly attached to an underside of the rockers by welding or using other fasteners.

In side impacts, the rockers 31, 32 receive energy which may potentially damage the battery box 20. It has been surprisingly found that by directly attaching the longitudinal outer members 11, 14 of the frame 10 to an underside of the rockers 31, 32, the energy produced by a side impact may be effectively absorbed and distributed throughout the frame 10 and a significant reduction of the energy received by the battery box may be achieved. Further, no space between the rockers 31, 32 is occupied, and such space may thus be occupied by the battery box 20. The size of the battery box 20 may thus be increased.

As illustrated in FIG. 6, the frame 10 may be fixed to the battery box 20 with at least one or more bolts. In this example, the battery box may be fixed to a bracket of the frame 10. The brackets may incorporate suitable bolt holes or other fastener holes.

A top perspective view of the frame 10 disclosed in FIG. 6 may be seen in FIG. 7. FIG. 7 shows the frame 10 fixed to a rectangular battery box 20 and to a first and second rockers 31, 32 of a vehicle. The longitudinal outer members 11, 14 of the frame 10 are directly attached to an underside of the rockers 31, 32 of the vehicle. In some examples, the longitudinal outer members 11, 14 of the frame 10 may be directly attached to an underside of the rockers 31, 32 once the frame 10 has been fixed to the battery box 20.

In case of a lateral collision, a longitudinal outer member 11, 14 of the frame 10 may receive energy and loads from a rocker 31, 32 and may absorb and transmit them through the cross-members 12 and 16 to the other side of the frame 10. The frame 10 may absorb and redistribute impact energy and the integrity of the battery box 20 may be protected.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

1. A vehicle comprising a battery box, a first rocker, a second rocker, and a frame for the protection of the battery box wherein
a longitudinal direction being defined as parallel to a driving direction of the vehicle, a lateral direction being defined as a horizontal direction perpendicular to the driving direction and a vertical direction being defined as perpendicular to the longitudinal direction and the lateral direction, and wherein
the frame (10) comprises:
a first longitudinal outer member generally extending along the longitudinal direction and directly attached to an underside of the first rocker,
a second longitudinal outer member generally extending along the longitudinal direction and directly attached to an underside of the second rocker and
a plurality of cross-members arranged to extend along the lateral direction underneath the battery box and connecting the first longitudinal outer member to the second longitudinal outer member,
wherein the of cross-members include one or more cross-members that are curved forwardly or rearwardly along the longitudinal direction.

2. The vehicle of claim 1, wherein two or more of the cross-members have the same size and shape.

3. The vehicle of claim 1, wherein at least two of the cross-members are joined to each other.

4. The vehicle of claim 1, wherein a first cross-member of the plurality of cross-members comprises a first end portion connecting to the first longitudinal outer member, a second end portion connecting to the second longitudinal outer member, and a curved middle portion, wherein the first and second end portions are positioned in substantially a same longitudinal position, and wherein the curved middle portion is positioned more rearwardly or forwardly than the first and second end portions

5. The vehicle of claim 4, wherein a second cross-member of the plurality of cross-members that is adjacent to the first cross-member is joined to the first cross-member the middle portion.

6. The vehicle of claim 1, wherein the plurality of cross-members are joined to the first and second longitudinal outer members by brackets.

7. The vehicle of claim 6, wherein at least two of the cross-members are joined to the first longitudinal outer member by a single bracket.

8. The vehicle of claim 6, wherein the first and second longitudinal outer members and the plurality of cross-members are joined to the brackets by welding.

9. The vehicle of claim 1, wherein the plurality of cross-members are tubes.

10. The vehicle of claim 1, wherein the plurality of cross-members are beams.

11. A The vehicle of claim 1, wherein the first and second longitudinal outer members have a substantially hollow cross-section.

12. The vehicle of claim 1, wherein the first and second longitudinal outer members are roll formed.

13. The vehicle of claim 1, wherein the first and second longitudinal outer members are made of an ultra high strength steel.

14. A The vehicle of claim 1, wherein the frame is fixed to a bottom of the battery box.

15. (canceled)

16. The vehicle of claim 1, wherein all the cross-members have the same size and shape.

17. The vehicle of claim 3, wherein the two of the cross-members are joined by spot welding.

18. A frame configured to be fixed to a bottom of a battery box of a vehicle, comprising:
a first longitudinal outer member generally extending along a longitudinal direction and configured to be directly attached to an underside of a first rocker, the longitudinal direction being defined as parallel to a driving direction of the vehicle;
a second longitudinal outer member generally extending along the longitudinal direction and configured to be directly attached to an underside of a second rocker; and
a plurality of cross-members extending generally along a lateral direction underneath the battery box and connecting the first longitudinal outer member to the second longitudinal outer member, the lateral direction being defined as a horizontal direction perpendicular to the driving direction,
wherein
each of a first cross-member of the plurality of cross-members and a second cross-member of the plurality of cross-members comprise a first end portion connecting to the first longitudinal outer member, a second end portion connecting to the second longitudinal outer member, and a curved middle portion, wherein
the first and second end portions are positioned in substantially a same longitudinal position, and
the curved middle portion of the first cross-member is positioned in a more rearward longitudinal position than the first and second end portions of the first cross-member,
the curved middle portion of the second cross-member is positioned in a more forward longitudinal position than the first and second end portions of the second cross-member, and
the middle portion of the first cross-member is joined to the middle portion of the second cross-member.

19. The frame according to claim 18, wherein the plurality of cross-members are tubes.

20. The frame of claim 18, wherein the first and second cross-member are joined to each other by welding or by a bracket.

21. A frame configured to be fixed to a bottom of a battery box of a vehicle, comprising:
a first longitudinal tube generally extending along a longitudinal direction and configured to be directly attached to an underside of a first rocker, the longitudinal direction being defined as parallel to a driving direction of the vehicle;
a second longitudinal tube generally extending along the longitudinal direction and configured to be directly attached to an underside of a second rocker; and
a plurality of cross-members extending generally along a lateral direction underneath the battery box and connecting the first longitudinal tube to the second longitudinal tube, the lateral direction being defined as a horizontal direction perpendicular to the driving direction,
wherein
a first cross-member of the plurality of cross-members is at least partially curved forward in the longitudinal direction, and
a second cross-member of the plurality of cross-members is at least partially curved rearward in the longitudinal direction, and
the plurality of cross-members are joined to the first and second longitudinal tubes by brackets.
